(19) United States
(12) Patent Application Publication
(10) Pub. No.: US 2009/0164307 A1
(43) Pub. Date: Jun. 25, 2009

(54) METHOD OF OPTIMIZING THE FILLING OF A STORAGE FACILITY

(75) Inventors: Valerie Ruiz Domingo, Boulogne Billancourt (FR); Jean-Michel Cabanes, Saint-Maur (FR); Alain Caracatzanis, Grezieu la Varenne (FR); Jacques Rottenberg, Paris (FR)

Correspondence Address: WEINGARTEN, SCHURGIN, GAGNEBIN & LEBOVICI LLP, TEN POST OFFICE SQUARE, BOSTON, MA, 02109, US

(73) Assignee: GAZ DE FRANCE, Paris (FR)

(21) Appl. No.: 12/338,106

(22) Filed: Dec. 18, 2008

(30) Foreign Application Priority Data
Dec. 20, 2007 (FR) 0760120

(51) Int. Cl. G06Q 10/00; G06Q 50/00

(52) U.S. Cl. 705/10

(57) ABSTRACT

According to the method of optimizing the filling of a storage facility for a raw material offered during a given subscription period (a) there are collected subscription demands DSₖ^{s} comprising for each subscriber first and second firm profiles PF₁^{s}, PF₂^{s} to quantify the foreseeable consumption capacity demands in a succession of predefined time intervals n; (b) a test is applied to all the second firm profiles PF₂^{s} for each of the time intervals n to determine if the corresponding consumption capacity is less than or equal to the total capacity CTn of the storage facility; (c) if the result of the preceding test is negative, a test is applied in the time intervals n in which the total capacity CTn of the storage facility is exceeded by the consumption capacity corresponding to all the second firm profiles PF₂^{s} to determine if the consumption capacity corresponding to one or more second firm profiles PF₂^{s} exceeds a threshold corresponding to a portion αCTn of the total capacity CTn of the storage facility; (d) if the result of the preceding test reveals that the threshold is exceeded, the second firm profiles PF₂^{s} that caused the threshold to be exceeded are replaced with the corresponding first firm profiles PF₁^{s}; (e) steps (b) and (c) are repeated; and (f) the worst classified first or second firm profiles PF₁^{s}, PF₂^{s} are progressively eliminated until the consumption capacity corresponding to all the first or second firm profiles PF₂^{s}, PF₁^{s} still retained no longer exceeds the total capacity CTn of the storage facility.

### FIELD OF THE INVENTION

The present invention relates to a method of optimizing the filling of a storage facility for a raw material offered to subscribers for consumption during a given future subscription period in order to satisfy over the longest time period the greatest possible number of subscribers from a set of subscribers having different foreseeable requirements in terms of consumption capacity.

### PRIOR ART

Bulk solid or liquid raw materials are frequently stored in storage facilities of large capacity during long periods of time in order to enable a number of operators to withdraw predetermined quantities of raw material over a period of time. The operators can be end consumers or more generally distributors who resell the raw material via distribution circuits. This applies in particular to the supply of energy when the raw material is a fossil fuel such as oil or liquefied natural gas.

The operators who consume the raw material stored in the storage facilities are highly diverse and can have very heterogeneous requirements that change over time. In the very common situation of sharing the raw material stored in a storage enclosure between a number of operators whose foreseeable requirements are known but heterogeneous, it is difficult to adapt the quantity of raw material stored both to respond to the requirements of users at a given time and to fill the available storage volume as completely as possible.

### DEFINITION AND OBJECT OF THE INVENTION

The present invention aims to remedy the above-mentioned drawbacks and to enable allocation of quantities of raw materials stored in a storage facility in a manner that both enables maximum filling of the storage facility and satisfaction of a greater number of potential clients from a set of subscribers who have communicated their foreseeable requirements in terms of consumption of raw material.

The above objects are achieved by a method of optimizing the filling of a raw material storage facility offered for consumption to subscribers during a given future subscription period in order to satisfy over the longest time period the greatest possible number of subscribers from a set of subscribers having different foreseeable requirements in terms of consumption capacity, including the following steps:

(a) establishing and collecting respective subscription demands DSₖ^{s} associated with the various subscribers to quantify the foreseeable demand in consumption capacity in a succession of predefined time intervals n during said given subscription period, the subscription demands DSₖ^{s} comprising for each subscriber a first firm profile PF₁^{s} corresponding to a subsidiary demand and a second firm profile PF₂^{s} corresponding to a main demand, the second firm profile PF₂^{s} comprising, for each time interval n, a capacity greater than that of the first firm profile PF₁^{s} of the same subscriber;

(b) applying a test to the second firm profiles PF₂^{s} of all the subscribers for each of the time intervals n of the subscription period to determine if the consumption capacity corresponding to all the second firm profiles PF₂^{s} is less than or equal to the total capacity CTn of the storage facility for each of those time intervals n;

(c) if the result of the preceding test is negative and reveals that the total capacity CTn of the storage facility cannot satisfy the consumption capacity corresponding to all the second firm profiles PF₂^{s}, applying a test in the time intervals n in which the total capacity CTn of the storage facility is exceeded by the consumption capacity corresponding to all the second firm profiles PF₂^{s} to determine if the consumption capacity corresponding to one or more second firm profiles PF₂^{s} exceeds a threshold corresponding to a portion αCTn of the total capacity CTn of the storage facility, where 0.25≦α0.50;

(d) if the result of the preceding test reveals that said threshold is exceeded, replacing in their entirety for all the subscription period the second firm profiles PF₂^{s} that caused a threshold to be exceeded with the corresponding first firm profiles PF₁^{s};

(e) repeating steps (b) and (c) and, if the result of the test of the step (b) is negative and if the result of the test of the step (a) still reveals that the threshold is exceeded, classifying the first or second firm profiles PF₂^{s}, PF₁^{s} retained to assign them to hierarchical categories as a function of the duration and the regularity of the subscribed consumption that they reflect; and

(f) progressively eliminating the worst classified first or second firm profiles PF₁^{s}, PF₂^{s} until the consumption capacity corresponding to all the first or second firm profiles PF₂^{s}, PF₁^{s} still retained no longer exceeds said total capacity CTn of the storage facility over all the time intervals n of the given subscription period.

During the step of classifying the retained first or second firm profiles PF₂^{s}, PF₁^{s} to assign them to hierarchical categories, there are advantageously retained first in one or more categories (A, B) to be given priority the first or second firm profiles PF₂^{s}, PF₁^{s} corresponding to a consumption capacity that remains above a given threshold during a number of time intervals n of the subscription period that is greater than a given value.

During the step of classifying the retained first or second firm profiles PF₂^{s}, PF₁^{s} to assign them to hierarchical categories, there are preferably retained in one or more categories (A) to be given priority the first or second firm profiles PF₂^{s}, PF₁^{s} corresponding to a consumption capacity that is stable or increasing in each time interval k relative to the preceding time interval throughout the subscription period.

According to one particular feature, during the step of classifying the retained first or second firm profiles PF₂^{s}, PF₁^{s} to assign them to hierarchical categories, the retained first or second firm profiles PF₂^{s}, PF₁^{s} in each category are classified in decreasing order of total consumption capacity over the entire subscription period.

The storage facility can have a variable total capacity that can vary extensibly and stepwise during the subscription period.

In one advantageous embodiment each subscription demand DSₖ^{s} further comprises for each subscriber a first extensible profile PE₁^{s} established for each time interval.

For allocating residual capacities of the storage facility as a function of the extensible profiles PE₁^{s}, priority is preferably further given to subscribers whose pre-allocated capacity according to the selected first or second firm profile is less than a threshold corresponding to a portion αCTn of the total capacity CTn of the storage facility, where 0.25≦α0.50.

The portion αCTn of the total capacity CTn of the storage facility advantageously represents one-third of that total capacity.

The given subscription period can comprise a number of years. The predefined time intervals n can then correspond to periods of one year or six months, for example.

The method according to the invention can in particular be applied to storing liquefied natural gas (LNG) in one or more storage facilities of a methane terminal and the subscribers can then be gas operators.

### BRIEF DESCRIPTION OF THE DRAWINGS

Other features and advantages of the present invention emerge from the following description of particular embodiments chosen by way of example, which description is given with reference to the appended drawings, in which:

FIGS. 1 and 2 respectively represent examples of subsidiary and main subscription demands in terms of raw material consumption capacity submitted by a subscriber for a given subscription period;

FIG. 3 is a flowchart showing the main steps of the method of the invention;

FIG. 4 is a flowchart showing one example of the steps of the method of the invention for effecting a classification using hierarchical categories;

FIG. 5 is a table showing one example of the result of classification using hierarchical categories;

FIG. 6 is a diagram illustrating the method of the invention, with the result of a first test for a set of main firm profiles submitted by three subscribers;

FIG. 7 is a diagram showing, for the FIG. 6 example, the result of a subsequent step of the method of the invention, with a subsidiary firm profile for one of the three subscribers;

FIG. 8 is a diagram showing one example of the application of the method of the invention, with the result of a first test for a set of main firm profiles submitted by six subscribers;

FIGS. 9 to 11 are diagrams showing, for the FIG. 8 example, the results of subsequent steps of the method of the invention, with a subsidiary firm profile for one of the six subscribers, followed by the elimination of two subscribers;

FIG. 12 is a diagram showing, for the example of FIGS. 8 to 11, the allocation of additional consumption capacities according to extendable profiles of the subscribers in one particular embodiment of the method of the invention; and

FIGS. 13 and 14 are diagrams showing, for the example of FIGS. 8 to 12, allocations of capacities to the various subscribers after additional steps of the method of the invention.

### DETAILED DESCRIPTION OF PREFERRED EMBODIMENTS

The method of the invention is applicable to any storage facility intended to contain raw material that is to be consumed by a set of users having predefined different consumption requirements that can change over time.

The storage facility can consist of one or more enclosures and can have a total capacity CT subject to change that can vary extensibly and stepwise over time.

The raw material can be any bulk solid or liquid material and in particular any type of fuel such as oil or liquefied gas.

The method of the invention is described by way of example with reference to a liquefied natural gas (LNG) storage terminal that can, for example, include a storage enclosure including one or more storage facilities with a capacity of several Gm³/year.

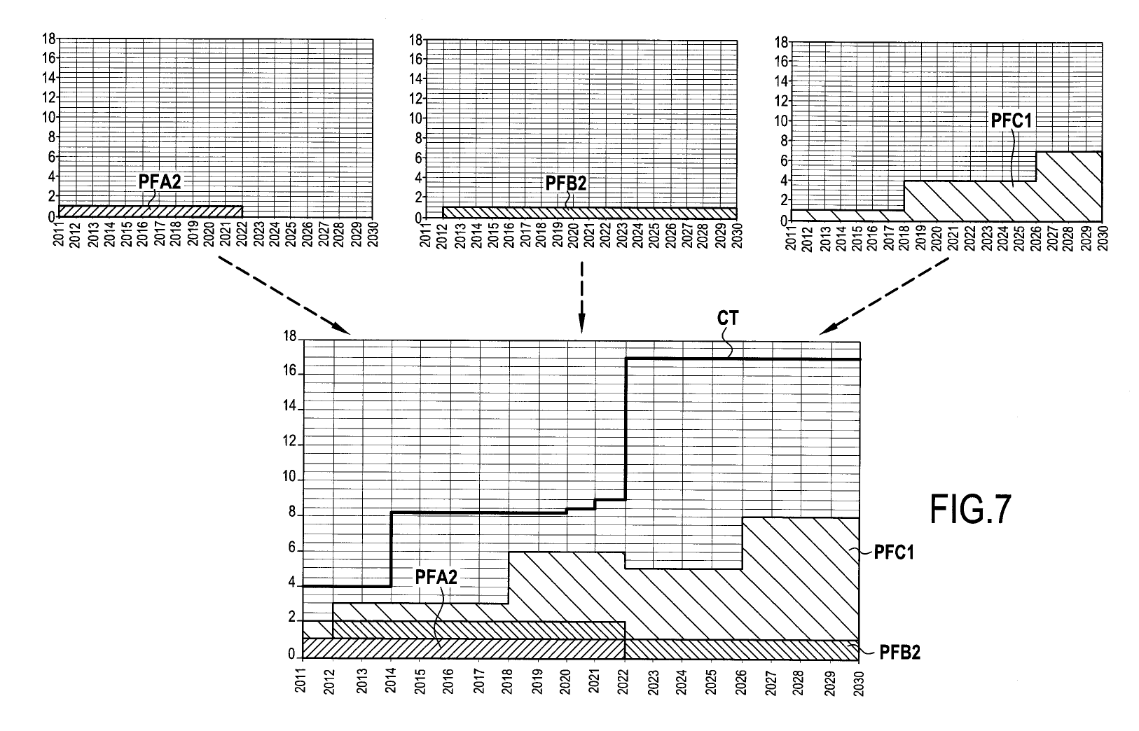

In the present example, which is in no way limiting on the invention, it is considered that the LNG storage terminal expands and thus includes a number of storage facilities whose total capacity CT is 4 Gm³/year for the years 2014 to 2019, 9 Gm³/year for the year 2020, 9.5 Gm³/year for the year 2021 and 16.5 G³/year for the years 2022 to 2030 (see FIGS. 6 to 14).

Given that potential users who will consume or remove stored raw material have requirements that are generally subject to change but essentially predefined, it is possible to identify a consumption capacity forecast for each potential user.

However, if the stored raw material is assigned at random to a set of successive potential users having heterogeneous demands, it is not possible to use the storage capacities of the storage facilities optimally. Depending on the various users chosen at random, for example according to a “first come, first served” rule, the cumulative raw material demands of the various users for different successive time periods can prove to be either very much lower or very much higher than the maximum storage capacity, so that some users may go unsatisfied, even high-volume users.

To be able to satisfy the greatest possible number of users over the longest possible time period despite the different requirements of the various users in terms of consumption capacity, the method of the invention organizes the sharing of consumption or withdrawal of the stored raw material between a number of potential users, who can be end users or intermediary operators associated with distribution circuits.

To this end, according to the invention, a given subscription period is determined that corresponds to a given future time period, from several months to several years, depending on the application. The example described with reference to the appended drawings considers a subscription period covering the years 2011 to 2035. This subscription period is divided into time intervals n, preferably of equal duration, which can correspond to quarterly, half-yearly or annual periods, for example. The remainder of the description considers time intervals n each corresponding to one year.

To organize satisfaction of the demands of potential users during the subscription period as well as optimizing the filling of the terminal with raw material, each potential user or subscriber establishes a subscription demand DSₖ^{s} that quantifies their forecast demand in terms of consumption capacity in the successive years of the subscription period.

A subscription demand DSₖ^{s} for each subscriber comprises a first firm profile PF₁^{s} corresponding to a first subsidiary demand and a second firm profile PF₂^{s} corresponding to a main demand.

The second firm profile PF₂^{s} for each annual time interval includes a capacity greater than that of the first firm profile PF₁^{s} of the same subscriber.

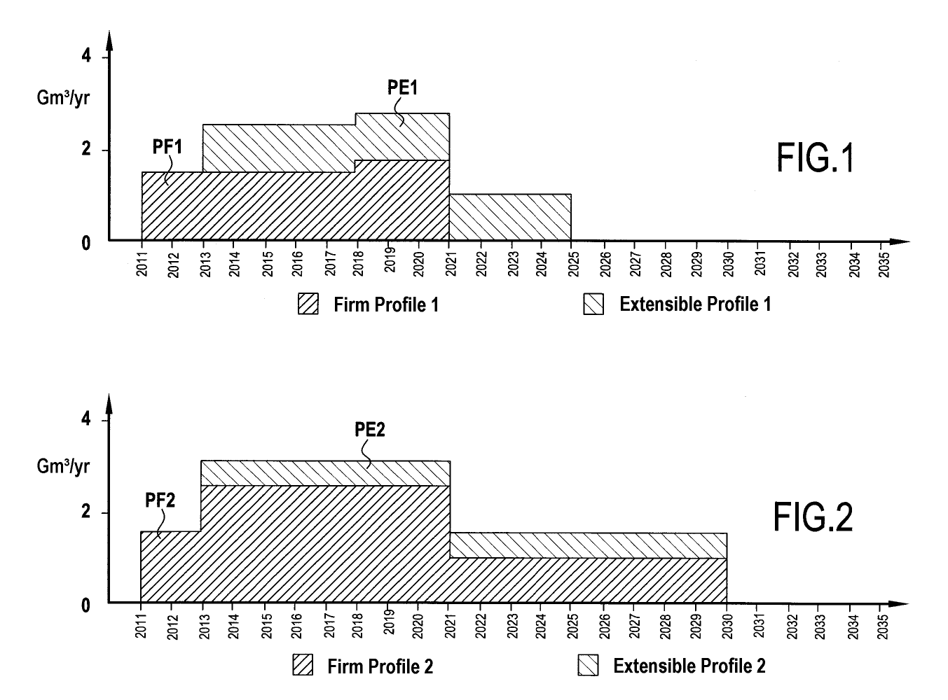

FIGS. 1 and 2 show an example of firm profiles PF1 and PF2 for one particular subscriber. Note that for the period 2011-2013 the two firm profiles PF1 and PF2 are identical, whereas PF2 is above PF1 at all times for the period 2014-2021. The value of PF1 is zero from 2022, while PF2 retains a non-zero value up to 2030.

FIGS. 1 and 2 also show that a subscription demand DSₖ^{s} can further include an extensible profile corresponding to an optional additional consumption demand associated with the firm profile(s) PF1 and/or PF2. Thus FIGS. 1 and 2 show extensible profiles PE1, PE2 associated with the firm profiles PF1, PF2, respectively.

Thus each subscription demand is expressed in the form of two consumption capacity profiles, namely a firm profile which, on completion of the allocation process, is either allocated in full (where appropriate subject to a marginal annual reduction less than or equal to 5%, for example), or not retained, and an extensible profile that corresponds to capacities additional to the firm profile, which can be allocated on a reduced scale in addition to the allocation of the firm profile.

Each subscription demand further includes a subsidiary demand and a main demand. For each year, the main demand has a firm profile PF2 that corresponds to a capacity greater than or equal to that of a firm profile PF1 of the subsidiary demand.

The method of the invention optimizes the filling of a storage facility such as a methane terminal as well as organizing non-discriminatory allocation that is transparent in that the allocation principles are clearly defined in advance.

The allocation of consumption capacity profiles over several years can apply in particular to the LNG regassification capacities of a methane terminal for operators involved in the LNG industry, who have undertakings over a long time period.

The fact that a subscription demand can include a first main demand and one or more lower level subsidiary demands facilitates adjustment of supply and demand.

Presentation of firm profiles and extensible profiles further allows for adjustment by distinguishing between what is essential and an optional additional demand.

The optimization method of the invention further guarantees that no subscriber will come to dominate and that the greatest number of demands will be satisfied (see below).

Similarly, the introduction of criteria for classifying firm profiles and allocating residual capacities pro rata and up to the limit of the extensible profiles means that allocation can be organized impartially.

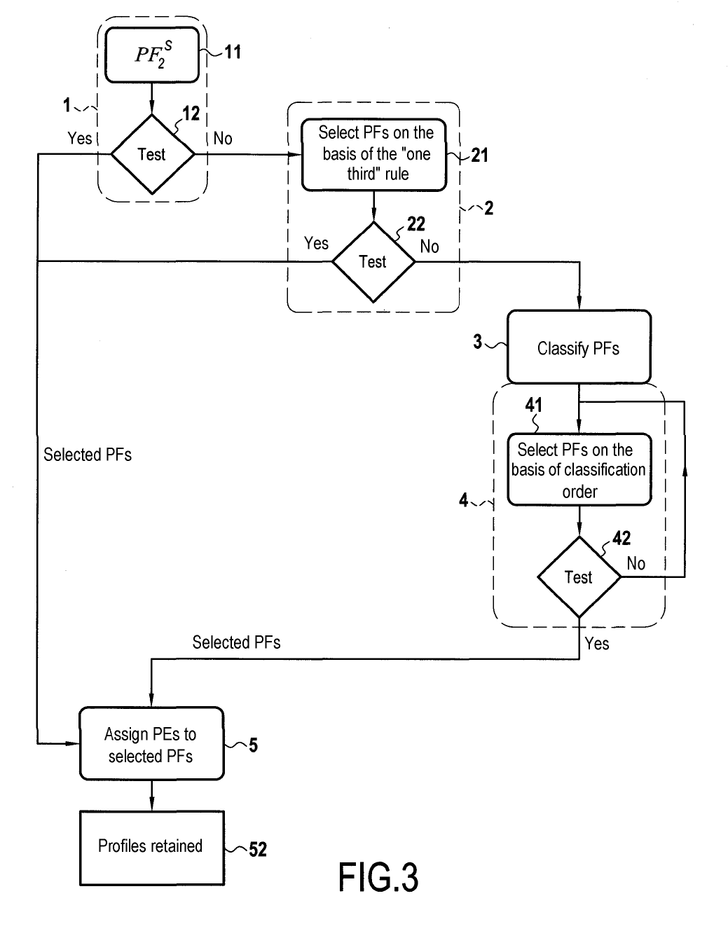

FIG. 3 shows the main steps of the method of the invention.

Once the subscription demands DSₖ^{s} associated with the various subscribers for a given subscription period have been established and collected as described above, there follows a first step 1 during which account is taken (step 11) of all the second firm profiles PF₂^{s} of all the subscribers for each of the time intervals n (each year) of the subscription period and a test is effected (step 12) to determine if the consumption capacity corresponding to all these second firm profiles PF₂^{s} is less than or equal to the total capacity CTn of the storage facility for each of those time intervals n.

If so, the second firm profiles PF₂^{s} considered are selected and there follows a step 5 described below.

In contrast, if the result of the step 12 test is negative, the next step is the step 2, because not all the firm profiles PF₂^{s} can be satisfied at least for one year.

The step 2 includes a step 21 of taking account of all the second firm profiles PF₂^{s} to effect, in a test step 22, selection based on a fractional rule (a fraction of between one quarter and one half, and preferably one third) to eliminate each second firm profile PF₂^{s} such that the capacity corresponding to that profile exceeds a portion αCTn of the total capacity CTn of the storage facility, where 0.25≦α≦0.50, for any time interval in which the total capacity CTn of the storage facility is exceeded by the consumption capacity corresponding to all the second firm profiles PF₂^{s}.

This ensures that, if more than the total capacity CTn of the storage facility is requested in a given year, no subscriber demands more than a predetermined fraction therefore, for example one third.

If the step 22 test reveals that a second profile PF₂^{s} does not satisfy the factional rule, the second profile PF₂^{s} that caused the threshold to be exceeded is replaced in its entirety for the whole of the subscription period by the corresponding first firm profile PF₁^{s}.

The steps 1 and 2 are then repeated with said first firm profile PF₁^{s} incorporated alongside the other second firm profiles PF₂^{s} and, if there the threshold is still exceeded during the step 22 test, the first firm profile PF₁^{s} is eliminated and the steps 1 and 2 are repeated again. If the step 22 again reveals that the threshold is exceeded, there follows the step 3 of classifying the first and second firm profiles PF₁^{s} and PF₂^{s} that have been adopted to assign them to hierarchical categories as a function of the duration and the regularity of the subscribed consumption that they reflect.

To summarize, if the step 2 employs a one-third rule to ensure that, if more than the total capacity is demanded in a given year, no subscriber demands more than one third thereof, the following processing is effected iteratively:

(i) seek the year in which the excess consumption demand is the greatest and at least one firm profile is greater than one third of the total capacity:

if a year is identified, go to step (ii);

if no year is identified, and if the one-third rule is satisfied, go to step 3;

(ii) for all firm profiles for which the capacity for the year identified in (i) is greater than one third of the total capacity for said year:

if the firm profile is a second firm profile PF₂^{s}, then that second firm profile PF₂^{s} is replaced by the corresponding first firm profile PF₁^{s};

if the firm profile is a first firm profile PF₁^{s}, then that first firm profile PF₁^{s} is excluded in its entirety;

(iii) on the basis of the first or second firm profiles PF₁^{s}, PF₂^{s} adopted in step (i):

if the total capacity CTn is sufficient, go to step 5;

if not, repeat step (i) to identify the year in which the excess demand is the greatest and go to step 3 for classifying the firm profiles, followed by the step 4 for selecting firm profiles on the basis of the classification order.

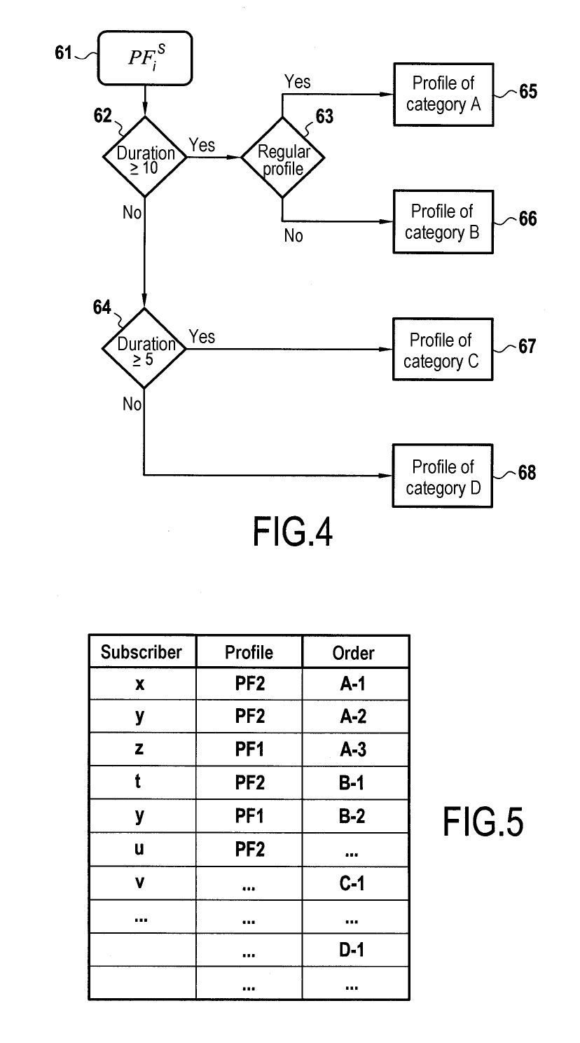

An example of the process of classifying firm profiles into categories is explained with reference to FIG. 4.

All the firm profiles PF₁^{s} retained before the classification step are taken into account in the step 61, whether they correspond to second firm profiles PF₂^{s} or to first firm profiles PF₁^{s}.

The firm profiles are first categorized as a function of duration and this categorization can, for example, take account of the number of years in which the consumption capacity linked to the firm profile exceeds a given threshold, for example 35 Mm³/year for an operator presenting a subscription demand for a methane terminal.

Categorization of the firm profiles also takes account of regularity. Thus a profile can be considered regular if the annual capacities are stable or increasing relative to the previous year throughout the period.

For example, FIG. 4 shows a test 62 for determining if the period in which the given threshold is exceeded is greater than or equal to a first predetermined value, for example 10 years. If so, a test 63 determines if the profile is regular. If the result is positive, the profile is classified in a first category A (step 65). If the result of the test 63 is negative, the profile is classified in a second category B (step 66).

If the result of the test 62 is negative, there follows in the step 65 a test for determining if the period for which the given threshold is exceeded is greater than or equal to a second predetermined value, for example 5 years. If so, the profile is classified in a third category C (step 67). If not, the profile is classified in a fourth category D (step 68).

Thus in this example the firm profiles are divided between four categories A, B, C, D in decreasing priority order.

Within each category, the firm profiles can be classified according to one or more additional criteria, for example the total volume of raw material subscribed, the firm profiles corresponding to the greatest subscribed total volumes being placed first.

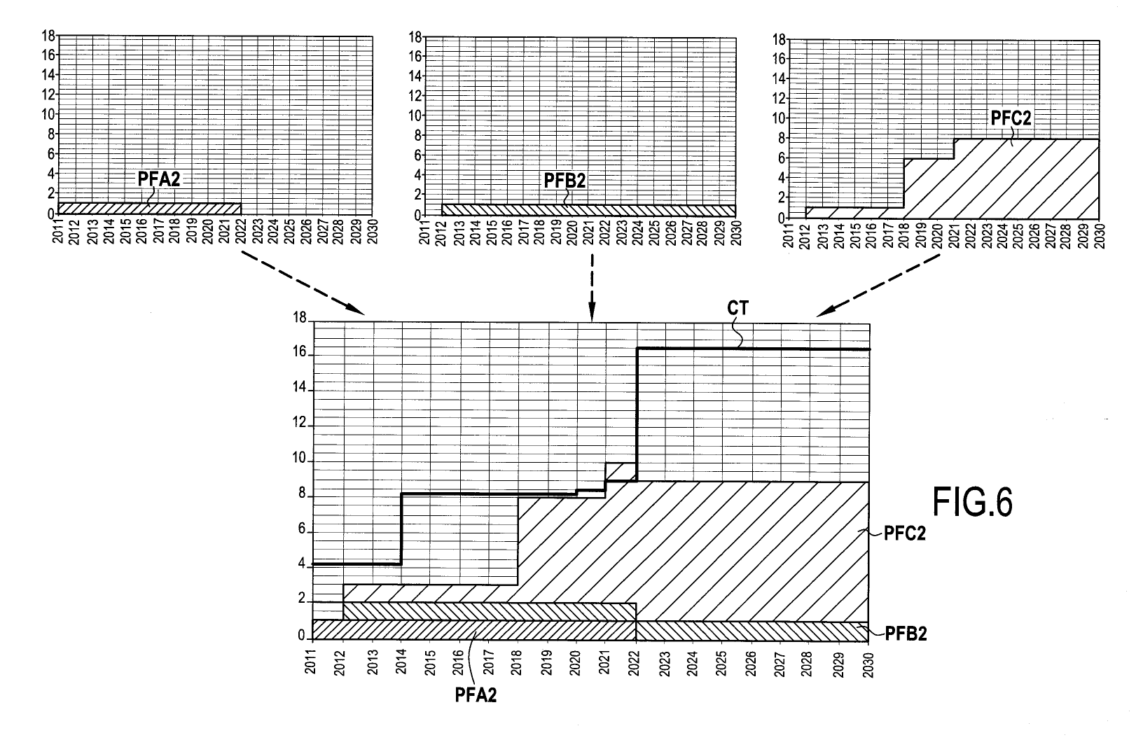

At the end of the step 3, all the firm profiles retained at this stage are classified in a classification order as shown by way of example in the FIG. 5 table.

Note that the same subscriber, for example the subscriber y, can have two firm profiles (PF1 and PF2) classified in this way, while other subscribers x, z, t, u have only one classified firm profile (PF1 or PF2).

In the step 4 in FIG. 3, the firm profiles retained and classified by category are selected automatically in classification order.

The selection process (step 41) and with a test 42 is effected so that at most one firm profile is retained for each qualified subscriber and so that the total capacity CTn of the terminal is not exceeded in any year.

The selected firm profiles are grouped together in an optional additional step 5 in which, if extensible profiles PE₁^{S}, PE₂^{S} have been included in the subscription demands DSₖ^{s}, there follows, after the firm profile selection steps, pre-allocation of capacities still available in the storage facilities of the terminal.

This pre-allocation is effected:

pro rata and within the limit of the extensible profiles;

giving priority to subscribers that do not already have a pre-allocated capacity (PF+PE) equal to or greater than a predetermined fraction (for example one third) of the total capacity.

The profiles finally retained, whether firm profiles or extensible profiles, are grouped together in the final step 52.

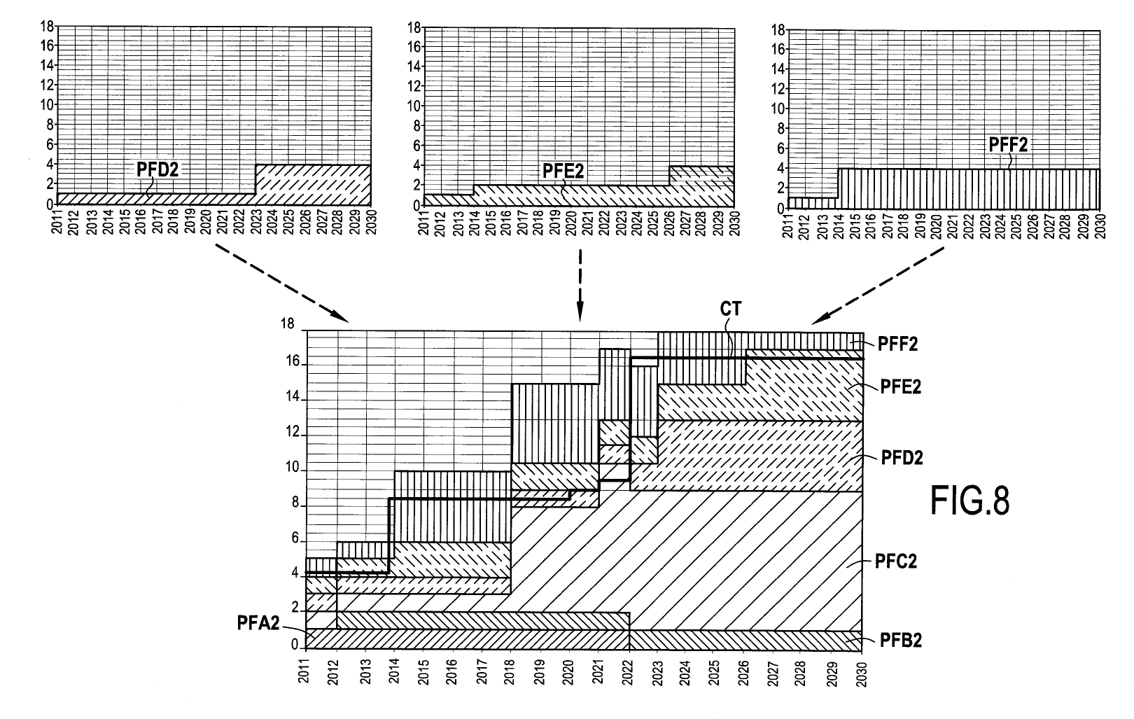

A process of allocating LNG consumption capacities of a methane terminal over a subscription period running from 2011 to 2030 with three demanders A, B, and C that, as subscribers, have proposed firm consumption capacity profiles is described by way of example next with reference to FIGS. 6 and 7.

The subscribers A and B have respectively submitted second firm profiles PFA2, PFB2 corresponding to main demands (see FIG. 6).

The subscriber C has submitted a second firm profile PFC2 corresponding to a main demand and a first firm profile PFC1 corresponding to a subsidiary demand (see FIGS. 6 and 7).

The selection criterion for step 2 of the FIG. 3 flowchart corresponds here to a one-third rule.

The summary diagram of FIG. 6 shows that, when all the second firm profiles PFA2, PFB2, PFC2 submitted by the subscribers A, B, C are taken into account, the total capacity CT of the terminal is insufficient for the year 2021.

The value of the second firm profile PFC2 of the subscriber C does not conform to the one-third rule applied in step 2 in FIG. 3.

According to the process described above, the second firm profile PFC2 of the subscriber C is replaced by the first firm profile PFC1 of the same subscriber C. After the test 12 of step 1 is applied again, it is found (see FIG. 7) that the total capacity CT of the terminal is sufficient for all years for all the profiles PFA2, PFB2, and PFC1.

The three demands of the subscribers A, B, C corresponding to two main demands and one subsidiary demand can all be satisfied, and so the process can terminate at step 5 in FIG. 3.

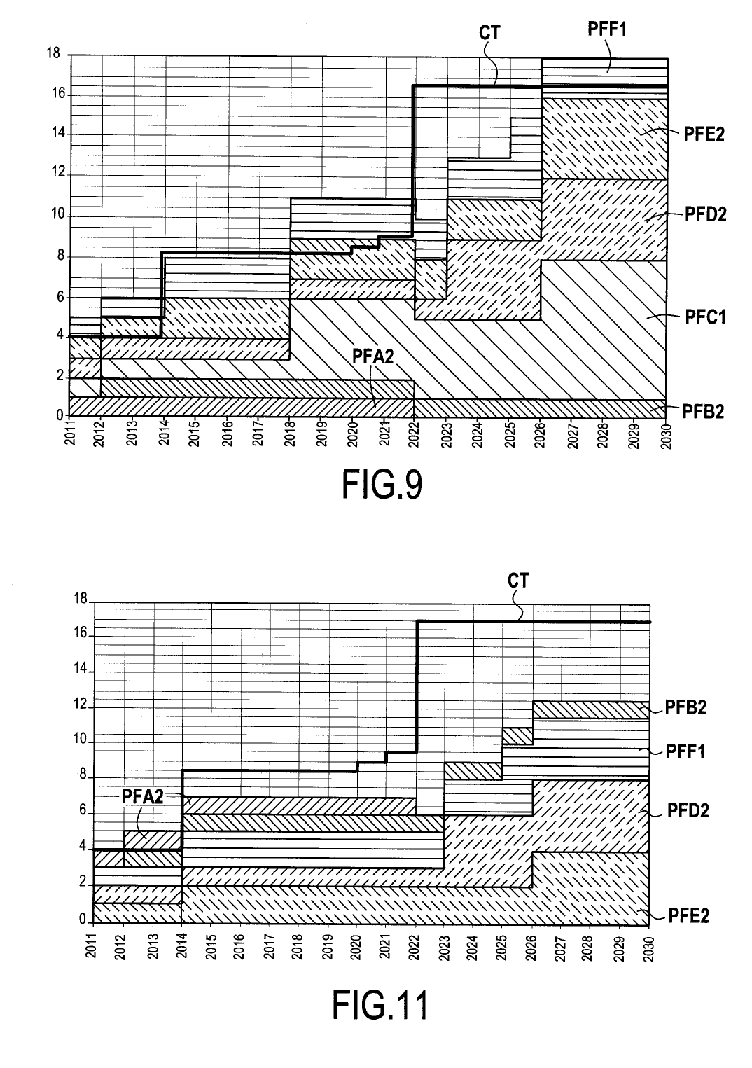

FIGS. 8 to 14 relate to another example in which the same terminal with a total capacity CT that changes over time, as shown in the figures, has to allocate consumption capacities for six different users A, B, C, D, E, and F.

The first three users A, B, and C have, as subscribers, formulated subscription demands identical to those described above with reference to FIGS. 6 and 7.

The other three users D, E, and F have, as subscribers, formulated subscription demands including respective second firm profiles PFD2, PFE2, and PFF2 (see FIG. 8).

Subscriber F has further formulated a subscription demand including a first firm profile PFF1 constituting a subsidiary demand (see FIG. 10).

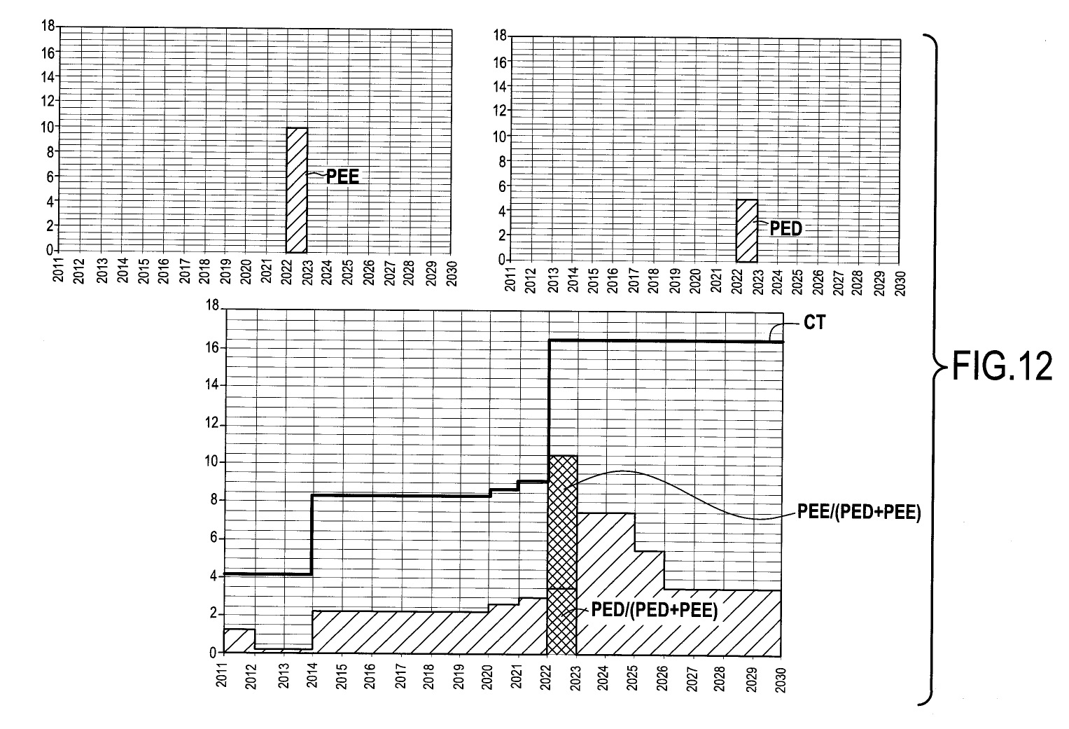

Subscribers D and E have also formulated subscription demands including respective extensible profiles PED and PEF (see FIG. 12, in which the extensible profiles PED and PEE are represented for the year 2022).

Note that in the FIG. 8 summary diagram the total capacity CT of the terminal is exceeded by the cumulative capacity demands of the second firm profiles PFA2, PFB2, PFC2, PFD2, PFE2, and PFF2 over several years, and is exceeded the most for the year 2018.

The test of step 2 of the FIG. 3 method shows that the second firm profiles PFC2 and PFF2 of subscribers C and F do not satisfy the one-third rule (a fraction equal to one third being chosen by way of example, as in the previous example).

The second firm profiles PFC2 and PFF2 of the main demands of the subscribers C and F are then replaced by the first firm profiles PFC1 and PFF1 of the subsidiary demands of the same subscribers C and F.

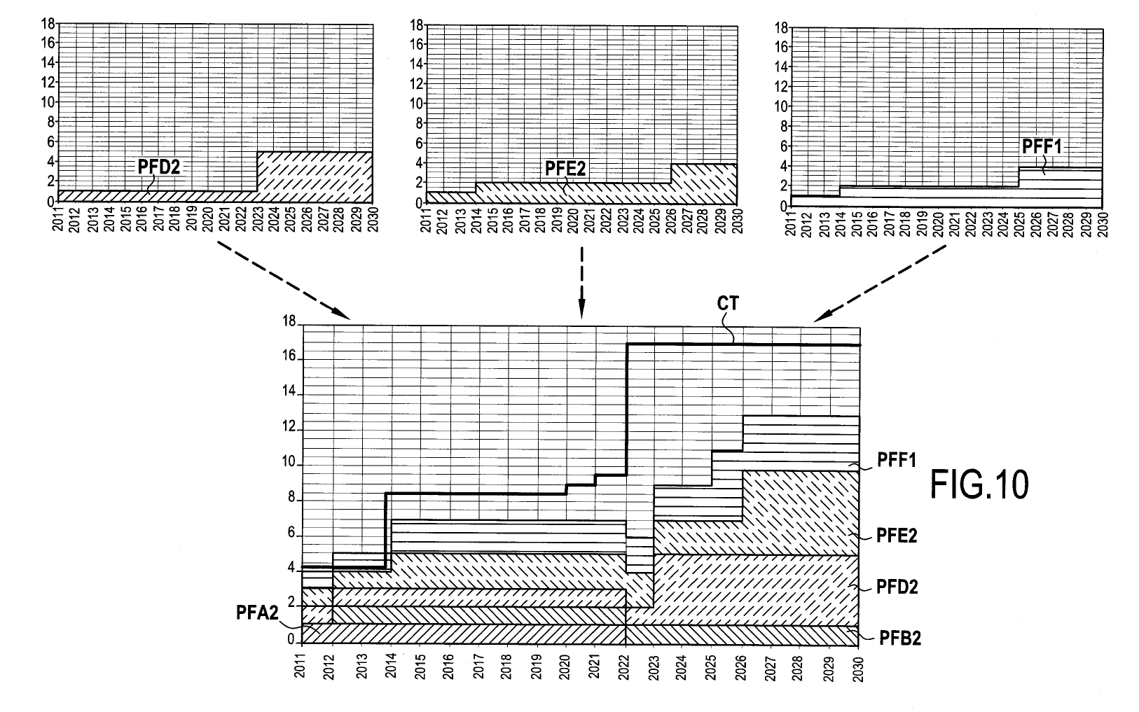

It is then found (FIG. 9) that the total capacity CT of the terminal is still exceeded the most in 2018. The test of step 2 of the FIG. 3 method then shows that, with the exception of the first firm profile PFC1 of subscriber C, all the firm profiles are less than one third of the total capacity in 2018.

Subscriber C is then finally set aside because it has a first firm profile PFC1 greater than CT/3 for the year 2018.

The process is then repeated with the users A, B, D, E, and F, taking into account the second firm profiles for the users A, B, D, and E and the first firm profile PFF1 for the user F.

The total capacity CT of the terminal remains insufficient in 2012 and 2013.

For these two years, all the firm profiles considered comply with the one-third rule of step 2 of the FIG. 3 method. Thus there follow a step 3 of classifying the firm profiles and a selection step 4.

In the present example, it is found that, after the FIG. 4 test 62, all the firm profiles have a duration greater than or equal to 10 years.

The FIG. 4 test 63 also reveals that all the profiles are regular.

The firm profiles PFA2, PFB2, PFD2, PFE2, and PFF1 are therefore all classified in category A (step 65 in FIG. 4).

Within this same category, the firm profiles are ordered in decreasing order as a function of the total volume corresponding to each profile. The priority order retained is then users E, D, F, B, and then A.

FIG. 11 is a summary diagram in which the firm profiles of the subscribers are rearranged in priority order (with the firm profile PFE2 of the highest priority subscriber E placed at the bottom of the diagram).

When the total capacity CT of the terminal remains insufficient in 2012, the subscriber A is set aside and only the firm profiles PFE2, PFD2, PFF1, and PFB2 are selected for application of step 5 from FIG. 3 concerning the possible allocation of extensible profiles to the selected firm profiles.

FIG. 12 shows the balance to be allocated year by year on a pro rata basis and within the limit of the extensible profiles associated with the selected firm profiles PFB2, PFD2, PFE2, and PFF1.

In 2022 in particular, only subscribers E and D have each expressed respective possible extensible profiles PEE and PED.

The following values apply in the FIG. 12 example: PEE=10 Gm³ and PED=5 Gm³.

Note that the sum of the two extensible profiles PEE and PED, which is 15 Gm³, is greater than the balance available in 2022 (that is 10.5 Gm³).

The following pre-allocation on a pro rata basis is then made:

for the subscriber E, PEE/(PEE+PED)=10/(10+5)

for the subscriber D, PED/(PEE+PED)=5/(10+5).

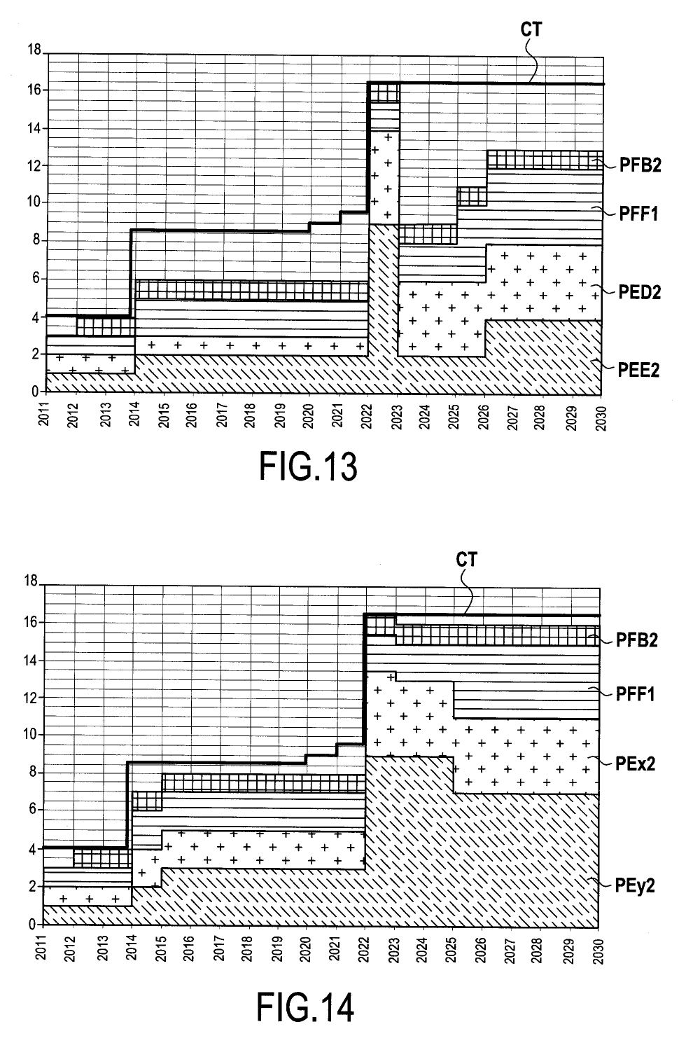

These capacities are added to the firm profiles already selected, see the FIG. 13 summary diagram) with the unchanged firm profiles PFB2 and PFF1 of the subscribers B and F and the profiles PED2 and PEE2 of the subscribers D and E with the benefit of extensible profiles.

The process continues for all years for which there remains a balance to be allocated to the extensible profiles.

FIG. 14 is a diagram showing the end result with the unchanged firm profiles PFB2 and PFF1 of the subscribers B and F and the profiles PEx2 and PEy2 of the subscribers D and E having the benefit of extensible profiles.

Note that in this example four subscribers (B, D, E, F) of the initial six subscribers (A to F) are pre-allocated consumption capacities and storage is optimized because little capacity still remains necessary to obtain the total capacity CT and the overall fill ratio is particularly regular.

The storage facility whose filling is to be optimized can have a capacity that changes over time. The invention also applies to a storage facility or a set of storage facilities having a basic volume that can be increased stepwise. The method of the invention can also be used to determine investments. One or more possible expansions of the capacity of a basic enclosure can therefore be effected or not effected as a function of the possibility or impossibility of filling them in an organized manner and sufficiently completely as a function of the demand of the users that have been requested to formulate subscription demands in accordance with the method of the invention.

Moreover, it is indicated above that according to the invention a subscriber can preferably present a main subscription demand and a subsidiary subscription demand.

The invention is not limited to two subscription demands per subscriber and it is possible to provide for a different number of subscription demands, for example a maximum number of five subscription demands per subscriber, the method being applied iteratively for the main subscription demands and then the successive subsidiary subscription demands.

One embodiment of the method of the invention is described below applied to a call for regassing capacity subscriptions to optimize the filling of a methane terminal over a multi-year subscription period corresponding to a future period, for example the period from 2011 to 2035, which is itself divided into a succession of time intervals each equal to one year.

In this example, the method is essentially applied to storage facilities related to three projects to expand the capacity of a pre-existing terminal, which expansions can correspond to three projects, each of which can itself change stepwise over time.

A total capacity CTₙ^{P} is therefore defined which corresponds, for each annual interval n of the subscription period, to the capacity associated with a given expansion project P (with P=0, 1, or 2).

Each subscriber formulates a subscription demand corresponding to an LNG regassing capacity reservation demand, undertaking to confirm this demand if some or all of the capacities demanded are allocated to them on application of the allocation rules of the method of the invention.

In the present example, a rule is applied to each subscriber of not exceeding one third of the total capacity or TCTₙ^{P} if the combination of subscription demands for a given annual period exceeds the total capacity CTₙ^{P} of an expansion project.

This one third of the total capacity TCTₙ^{P} thus represents for each interval n of the subscription period one third of the total capacity of the expansion project P concerned (with P=0, 1, or 2).

The subscription demand (DS) consists of two profiles:

a firm profile (PF) that comprises a series of capacities expressed annually associated with subscription period intervals and that the qualified subscriber wishes to be allocated entirely over each of the intervals;

an extensible profile (PE) that comprises a series of capacities expressed annually that the qualified subscriber wishes to be allocated, either over and above the firm profile or independently thereof, over each of the intervals—possibly to a reduced degree over one or more intervals should such reduction be effected at the time of capacity allocation.

A qualified subscriber S can submit up to five subscription demands DSₖ^{s} k=1, 2, . . . , 5, their combined subscription demands constituting what is referred to as their complete subscription demand.

For a given interval n of the subscription period, the k^{th} subscription demand of the complete subscription demand is expressed by the following formula:

DS_{k,n}^{S}=PF_{k,n}^{S}+PE_{k,n}^{S}

The terms DS_{K}^{S}, PFₖ^{S}, and PEₖ^{S} respectively correspond to the k^{th} subscription request, the firm profile, and the extensible profile of the complete subscription demand submitted by the qualified subscriber S.

If a qualified subscriber is not allocated a firm profile at the end of step 1, 2, or 4 of the allocation process shown in FIG. 3, they may nevertheless be allocated some or all of the capacities associated with one of their extensible profiles if, and only if, said qualified subscriber has indicated in their complete subscription demand the extensible profile that they wish to be allocated in step 5 of the allocation process independently of the allocation of the firm profile.

To be deemed valid, a complete subscription demand must be such that, for any interval n of the subscription period and for any subscription demand k of the complete subscription demand, the capacities PF_{k,n}^{S} of subscription demand DSₖ^{S} are greater than or equal to the capacities of the subscription demand DSₖ₊₁^{S}, in other words:

∀k,n: PF_{k,n}^{S}≧PF_{k+1,n}^{S} k=1, 2, 3, 4 and n=1; 2; . . . , 26 and, for any k, there exists at least one interval n such that PF_{k,n}^{S}≧PF_{k+1,n}^{S}.

For each expansion project P (with P=0, 1, or 2), the method of the invention allocates capacities to the qualified subscribers through the following five steps:

### Step 1—Firm Profile Satisfaction Test

The profiles PF₁^{S} are selected which correspond below to a main demand and it is verified if the sum of the capacities associated with the profiles PF₁^{S}—these capacities being, as required over one or more given intervals, all reduced in the same proportion for all of the qualified subscribers up to a maximum of 5% of the capacities concerned—is less than or equal to the total capacity for each of the intervals of the subscription period.

If so, those firm profiles are selected, and are then referred to as selected firm profiles, taking account of the capacities that may have been reduced to a maximum level of 5%, and there follows step 5.

If not, the one-third rule is applied, as in step 2.

### Step 2: Selection on the Basis of the “One Third” Rule

After selecting the firm profiles demanded by the qualified subscribers, the interval of the subscription period is identified for which the difference between the sum of the capacities of the firm profiles previously selected for all the qualified subscribers and the total capacity of the expansion project concerned is greatest.

For that interval n, and for each qualified subscriber S, of the previously selected firm profiles there is selected:

either the firm profile PF₁^{S}, if it is less than or equal to one-third of the total capacity, in other words if PF_{1,n}^{S}≦TCTₙ^{P}, where TCTₙ^{P} is equal to one-third of the total capacity of the interval n, for the expansion project P concerned;

or the firm profile PF₂^{S} of a first subsidiary demand substituted for the firm profile PF₁^{S} set aside on the basis of the preceding rule; note that if the qualified subscriber S submits in their complete subscription demand only one subscription demand, then that qualified subscriber is definitively excluded.

For each qualified subscriber S not excluded following the above test, the firm profile kₛ selected according to that test is denoted PFₖ_{ₛ}^{S}.

Whether the sum of the capacities associated with the profiles PFₖ_{ₛ}^{S}—these capacities being as required over one or more given intervals all reduced in the same proportion for all of the qualified subscribers up to a maximum of 5%—is less than or equal to the total capacity for each of those intervals is verified:

if so, then these firm profiles are selected, and are below referred to as selected firm profiles, taking account of the capacities that may have been reduced in the same proportion up to a maximum of 5%; there then follows the step 5;

if not, there follow the following steps:

The interval of the subscription period is identified for which:

for all qualified subscribers who have not previously been excluded PFₖ_{ₛ}^{S}, the difference between the sum of the capacities of the firm profiles previously selected and the total capacity of the expansion project concerned is the greatest;

at least one of the firm profiles of the qualified subscribers who have not been excluded beforehand is strictly greater than one third of the total capacity, namely for which there exists one qualified subscriber S (not previously excluded) such that:

PEₖ_{ₛ}_{,n}^{S}>TCTₙ^{P}

For this interval n, and for each qualified subscriber S, of the firm profiles previously selected there is then selected:

either the firm profile PFₖ_{ₛ}₊₁^{S} if it is less than or equal to one-third of the total capacity, namely if:

PFₖ_{ₛ}_{,n}^{S}≦TCTₙ^{P}

or the firm profile substituted for the firm profile set aside on the basis of the preceding point. If the index kₛ is equal to the number of firm profiles demanded in their complete subscription demand, the qualified subscriber S is definitively excluded; if the index kₛ is strictly less than the number of firm profiles demanded in the complete subscription demand by the qualified subscriber, kₛ is redefined as being equal to kₛ+1.

For each qualified subscriber S not excluded by the above test, the firm profile selected by the test is denoted PFₖ_{ₛ}^{S}.

Whether the sum of the capacities associated with the profiles PFₖ_{ₛ}^{S}—those capacities being, if required, over one or more given intervals, all reduced in the same proportion and up to a maximum of 5%—is less than or equal to the total capacity for each of the intervals is verified:

if so, these firm profiles are then selected, and are thereafter referred to as selected firm profiles, taking account of the capacities that may have been reduced in the same proportion up to a maximum of 5%, and there follows the step 5;

if not, then:

if all the intervals of the subscription period are such that the firm profiles of the qualified subscribers that have not been excluded in step 2 are less than or equal to one-third of the total capacity, namely if PFₖ_{ₛ}_{,n}^{S}≦TCTₙ^{P}, then step 3 follows;

if not, the preceding tests are repeated.

### Step 3—Classification of Firm Profiles

Starting from the situation as described at the end of step 2, there is determined the order of classification of all firm profiles that have not been set aside at the end of step 2 by application of the tests, that is to say a list of those firm profiles ordered in accordance with the above rules. Note that, a number of firm profiles can be classified in the classification order for the same qualified subscriber given that, in the end, in accordance with the description of step 4, at most one firm profile can be retained per qualified subscriber.

In a first stage, the following are calculated for each firm profile of the k^{th} subscription demand of a qualified subscriber S:

the duration of the firm profile PFₖ_{ₛ}^{S}, defined as the greatest sum of the interval durations DRₙ associated with consecutive intervals and such that, for example: PF_{n,k}^{S}≧0.04 Gm³/year;

the regularity of the firm profile PFₖ_{ₛ}^{S}, defined as the sum of the durations of the intervals DRₙ taken into account to calculate the duration of the firm profile PFₖ_{ₛ}^{S}, associated with intervals such that the capacities expressed in the firm profile are constant or increasing, that is to say, for example:

PF_{k,n+1}^{S}≧PF_{k,n}^{S}≧0.04 Gm³/year

Four categories (A, B, C, and D) of firm profiles are then considered, as shown in FIG. 4. Each firm profile is classified in one of these categories based on its duration and regularity. The firm profiles:

of duration and of regularity greater than or equal to 10 years are classified in category A;

of duration greater than or equal to 10 years and of regularity strictly less than 10 years are classified in category B;

of duration greater than or equal to 5 years and strictly less than 10 years are classified in category C;

of duration strictly less than 5 years are classified in category D.

The firm profiles of category A are considered to have the highest priority, then those of category B, then those of category C, and then those of category D.

If there is more than one firm profile in a given category, then the firm profiles in each category are classified in decreasing overall level order, i.e. giving the highest priority to firm profiles with a high overall level. The overall level of a firm profile is defined as the sum of the capacities demanded by the qualified subscriber in the firm profile weighted by the duration of the intervals, in other words:

$${NG}_{k}^{S} = {\sum }_{n} {PF}_{k , n}^{S} {DR}_{n}$$

If, by application of the above, firm profiles of the same category are classified ex aequo, these firm profiles with the same overall level are classified in increasing horizon order, i.e. giving the highest priority to the firm profiles with a low horizon. The horizon of a firm profile is defined as the average of the capacities demanded by the qualified subscriber in the firm profile weighted by the end of interval delays, in other words:

$${H}_{k}^{S} = \frac{{\sum }_{n} {DFI}_{n} \cdot {PF}_{k , n}^{S}}{{NG}_{k}^{S}}$$

where DFIₙ is the end of interval delay n defined as follows:

$${DFI}_{n} = 3 + {\sum }_{j = 1}^{n} {DR}_{j}$$

If, by application of the above, firm profiles of the same category are classified ex aequo, those firm profiles with the same overall level and the same horizon are classified in order of decreasing regularity, i.e. giving the highest priority to the firm profiles of high regularity.

If, by application of the above, firm profiles are ex aequo, the firm profiles with the same overall level, the same horizon and the same regularity are decided on by drawing lots.

At the end of the process described above, the order of classification of the firm profiles of the qualified subscribers that were not excluded after step 2 by applying tests has been established. Rank 1 is then assigned to the highest priority firm profile in the classification order, then rank 2 to the next firm priority profile, and so on, until all of the firm profiles have been considered.

### Step 4—Selection of Firm Profiles

The firm profiles are selected in the classification order established beforehand in step 3 so that, for each of the intervals of the subscription period, the sum of the capacities associated with the firm profiles is less than or equal to the total capacity, taking account as necessary of a rate of reduction of capacity applied uniformly to all the qualified subscribers independently for one or more given intervals and up to a maximum of 5%.

The procedure for this is as follows:
R1) The highest priority firm profile in the classification order is taken first, i.e. the firm profile of rank 1;
R2) There is then identified the first firm profile that is of higher rank than the rank previously identified and is not associated with a qualified subscriber for which a firm profile has previously been retained, according to rule R1 above or rule R4 below;
R3) For each of the intervals of the subscription period, there is then calculated the sum of the capacities associated with the firm profiles previously retained and the capacities associated with the firm profile of the rank identified under rule R2;
R4) If this sum—the capacities being, as required over given interval(s), all reduced in the same proportion and up to a maximum of 5%—is less than or equal to the total capacity for all the intervals of the subscription period; then

the firm profile previously identified under rule R2 is retained; and

rule R2 is applied again, unless the last rank identified does not correspond to the last rank of the classification order, in which case rule R6 applies.
R5) If not, the identified firm profile is not retained and rule R2 applies, unless the last rank identified does not correspond to the last rank of the classification order, in which case rule R6 applies.
R6) Taking account of capacities that may have been reduced in the same proportion up to a maximum of 5%, the firm profiles retained under rules R1 to R5 are named as the selected firm profiles, after which there follows step 5.
   Step 5—Allocation of the Capacities Associated with the Extensible Profiles

For each of the intervals of the subscription period:

the total remaining capacities 1 are identified as the difference between the total capacity and the sum of the firm profiles selected at the end of step 1, 2, or 4 for the interval concerned, which is denoted CTR1ₙ for the interval n;

the M qualified subscribers are identified who:

were allocated a selected firm profile at the end of step 1, 2, or 4; or

were not allocated a selected firm profile at the end of step 1, 2, or 4 but have notified that they wish to be allocated an extensible profile independently of the allocation of their firm profiles; to allocate capacities associated with the extensible profiles, the qualified subscribers concerned are considered to have been allocated corresponding null selected firm profiles at the end of step 1, 2, or 4.

For each of these M qualified subscribers, there is identified the extensible profile k corresponding to the selected firm profile k (possibly a null profile), i.e. the extensible profile formulated by the qualified subscriber in the same subscription demand k, referred to below as the selected extensible profile.

The remaining total capacities are allocated to these M qualified subscribers on the basis of the selected extensible profiles and also their selected firm profiles (possibly null profiles), in accordance with the following rules R7 to R11.

For a given interval:
R7) if the sum of the capacities of the selected extensible profiles is less than or equal to the remaining total capacity, then, for that interval, the capacities of the selected extensible profiles are allocated to the qualified subscribers that formulated them;

if the sum of the capacities of the selected extensible profiles is strictly greater than the remaining total capacity, then:
R8) initially, of the M qualified subscribers, there are identified the qualified subscribers whose capacity associated with the selected firm profile denoted PFSₙ^{S} is strictly less than one-third of the total capacity and each of these qualified subscribers is allocated a capacity equal to the smallest of:

the remaining total capacity 1 of the interval n, CTR1ₙ, reduced proportionately to the capacity of the selected extensible profile of the subscriber S, denoted PESₙ^{S}, that is to say:

$$\frac{{PES}_{n}^{S}}{{\sum }_{i = 1}^{m} {PES}_{n}^{i}} \times CTR {1}_{n}$$

the difference between one third of the total capacity and the capacity of the selected firm profile of the subscriber S for the interval n, that is to say:

TCTₙ−PFSₙ^{S}

the capacity of the selected extensible profile of the subscriber S, that is to say:

PESₙ^{S}
R9) the remaining total capacity 2, denoted CTR2ₙ, is then calculated as the difference between the remaining total capacity 1 and the capacities allocated to the qualified subscribers by applying rule R8, that is to say:

$$CTR {2}_{n} = CTR {1}_{n} - {\sum }_{j = 1}^{m} min ( \frac{{PES}_{n}^{1}}{{\sum }_{i = 1}^{m} {PES}_{n}^{i}} \times CTR {1}_{n} , {TCT}_{n} - {PFS}_{n}^{J} , {PES}_{n}^{J} )$$

R10) for each of the M qualified subscribers the remaining extensible profile PERSₙ^{S} selected for the interval n is defined as the difference between the capacity of their selected extensible profile PESₙ^{S} and the capacity allocated, where applicable by applying rule R8;
R11) the remaining total capacity CTR2ₙ is allocated to the M qualified subscribers pro rata their selected remaining extensible profiles PERSₙ^{S} for the interval concerned and within the limit of the profiles, that is:

$$\frac{{PERS}_{n}^{S}}{{\sum }_{T = 1}^{M} {PERS}_{n}^{T}} \times CTR {2}_{n}$$

R12) after this step 5, each of the M qualified subscribers should have been allocated:

a selected firm profile, unless the qualified subscriber has not opted to be allocated capacities associated with one of their extensible profiles in the absence of allocation of a firm profile; and

capacities under the selected extensible profiles and the remaining selected extensible profiles of these M qualified subscribers.

The sum of the capacities associated with the selected firm profile and the capacities associated with the extensible profile that have been allocated to a given qualified subscriber is referred to as the allocated capacities and denoted CAₙ^{S}.

To summarize, depending on the rules applied in the above step 5 and for a given project P, the capacity CAₙ^{S} allocated to the qualified subscriber S for the interval n is such that:

if the sum of the capacities of the selected extensible profiles is less than or equal to the remaining total capacity, then the selected extensible profiles are entirely allocated to the qualified subscribers that demanded them, in addition to their selected firm profiles (possibly null profiles):

CAₙ^{S}=PFSₙ^{S}+PESₙ^{S}

if the sum of the capacities of the selected extensible profiles is strictly greater than the remaining total capacity, then the selected extensible profiles are allocated proportionately to the various qualified subscribers that demanded them, in addition to their selected firm profiles (possibly null profiles), and giving priority to subscribers whose selected firm profile is strictly less than one third of the total capacity for the interval concerned:

$${CA}_{n}^{S} = \{ \begin{matrix}{PFS}_{n}^{S} + min ( \begin{matrix}\frac{{PES}_{n}^{S}}{{\sum }_{j = 1}^{m} {PES}_{n}^{J}} \times CTR {1}_{n} , \\ {TCT}_{n} - {PFS}_{n}^{S} , {PES}_{n}^{S}\end{matrix} ) + \frac{{PERS}_{n}^{S}}{{\sum }_{T = 1}^{M} {PERS}_{n}^{T}} \times \begin{matrix}CTR {2}_{n} si \\ {PES}_{n}^{S} < {TCT}_{n}\end{matrix} \\ \begin{matrix}{PFS}_{n}^{S} + \frac{{PERS}_{n}^{S}}{{\sum }_{T = 1}^{M} {PERS}_{n}^{T}} \times CTR {2}_{n} & si {PFS}_{n}^{S} \geq {TCT}_{n}\end{matrix}\end{matrix} \}$$

The method of the invention adopts an automatic and non-discriminatory approach to optimized filling of storage facilities with optimized allocation of regassing (or stored raw material) processing capacities and where appropriate means that investment in construction of such storage facilities need not be undertaken before verifying that their filling capability has been optimized.

What is claimed is:

1. A method of optimizing the filling of a raw material storage facility offered for consumption to subscribers during a given future subscription period in order to satisfy over the longest time period the greatest possible number of subscribers from a set of subscribers having different foreseeable requirements in terms of consumption capacity;
the method including the following steps:
(a) establishing and collecting respective subscription demands DSₖ^{s} associated with the various subscribers to quantify the foreseeable demand in consumption capacity in a succession of predefined time intervals n during said given subscription period, the subscription demands DSₖ^{s} comprising for each subscriber a first firm profile PF₁^{s} corresponding to a subsidiary demand and a second firm profile PF₂^{s} corresponding to a main demand, the second firm profile PF₂^{s} comprising, for each time interval n, a capacity greater than that of the first firm profile PF₁^{s} of the same subscriber;
(b) applying a test to the second firm profiles PF₂^{s} of all the subscribers for each of the time intervals n of the subscription period to determine if the consumption capacity corresponding to all the second firm profiles PF₂^{s} is less than or equal to the total capacity CTn of the storage facility for each of those time intervals n;
(c) if the result of the preceding test is negative and reveals that the total capacity CTn of the storage facility cannot satisfy the consumption capacity corresponding to all the second firm profiles PF₂^{s}, applying a test in the time intervals n in which the total capacity CTn of the storage facility is exceeded by the consumption capacity corresponding to all the second firm profiles PF₂^{s} to determine if the consumption capacity corresponding to one or more second firm profiles PF₂^{s} exceeds a threshold corresponding to a portion αCTn of the total capacity CTn of the storage facility, where 0.25≦α0.50;
(d) if the result of the preceding test reveals that said threshold is exceeded, replacing in their entirety for all the subscription period the second firm profiles PF₂^{s} that caused a threshold to be exceeded with the corresponding first firm profiles PF₁^{s};
(e) repeating steps (b) and (c) and, if the result of the test of the step (b) is negative and if the result of the test of the step (a) still reveals that the threshold is exceeded, classifying the first or second firm profiles PF₂^{s}, PF₁^{s} retained to assign them to hierarchical categories as a function of the duration and the regularity of the subscribed consumption that they reflect; and
(f) progressively eliminating the worst classified first or second firm profiles PF₁^{s}, PF₂^{s} until the consumption capacity corresponding to all the first or second firm profiles PF₂^{s}, PF₁^{s} still retained no longer exceeds said total capacity CTn of the storage facility over all the time intervals n of the given subscription period.

2. A method according to claim 1, wherein during the step of classifying the retained first or second firm profiles PF₂^{s}, PF₁^{s} to assign them to hierarchical categories, there are retained first in one or more categories (A, B) to be given priority the first or second firm profiles PF₂^{s}, PF₁^{s} corresponding to a consumption capacity that remains above a given threshold during a number of time intervals n of the subscription period that is greater than a given value.

3. A method according to claim 1, wherein during the step of classifying the retained first or second firm profiles PF₂^{s}, PF₁^{s} to assign them to hierarchical categories, there are retained in one or more categories (A) to be given priority the first or second firm profiles PF₂^{s}, PF₁^{s} corresponding to a consumption capacity that is stable or increasing in each time interval k relative to the preceding time interval throughout the subscription period.

4. A method according to claim 1, wherein during the step of classifying the retained first or second firm profiles PF₂^{s}, PF₁^{s} to assign them to hierarchical categories, the retained first or second firm profiles PF₂^{s}, PF₁^{s} in each category are classified in decreasing order of total consumption capacity over the entire subscription period.

5. A method according to claim 1, wherein the storage facility has a variable total capacity that can vary extensibly and stepwise during the subscription period.

6. A method according to claim 1, wherein each subscription demand DSₖ^{s} further comprises for each subscriber a first extensible profile PE₁^{s} established for each time interval.

7. A method according to claim 6, wherein for allocating residual capacities of the storage facility as a function of the extensible profiles PE₁^{s}, priority is further given to subscribers whose pre-allocated capacity according to the selected first or second firm profile is less than a threshold corresponding to a portion αCTn of the total capacity CTn of the storage facility, where 0.25≦α0.50.

8. A method according to claim 1, wherein the portion αCTn of the total capacity CTn of the storage facility represents one-third of that total capacity.

9. A method according to claim 1, wherein the given subscription period comprises a number of years and the predefined time intervals n correspond to periods of one year or six months.

10. A method according to claim 1, applied to storing liquefied natural gas in one or more storage facilities of a methane terminal and the subscribers are gas operators.
